(19) United States
(12) Patent Application Publication
(10) Pub. No.: US 2017/0316529 A1
(43) Pub. Date: Nov. 2, 2017

(54) SYSTEM AND METHOD TO GENERATE RECOMMENDATIONS BASED ON CURRENT AND PREDICTED EVENTS ABOUT A USER

(71) Applicant: Keith Landis, Lancaster, PA (US)

(72) Inventor: Keith Landis, Lancaster, PA (US)

(21) Appl. No.: 15/143,600

(22) Filed: May 1, 2016

(51) Int. Cl. G06Q 50/20; G06Q 10/10

(52) U.S. Cl. CPC G06Q 50/2053; G06Q 10/10

(57) ABSTRACT

The present disclosure relates to a system and method to analyze, predict, and provide recommendations to a user based on the current financial situation and current life situation of the user. For instance, the system and method may provide the user with a series of questions, such as in the form of a questionnaire, that the user provides answers to. From here, a control server may analyze the answers and make future projections or predictions about the individual's life, finances, and the effects of various changes in the individual's life on his or her finances. From here, if the individual is attending a post-secondary educational institution, current recommendations and future recommendations may be provided to the user based on the analysis and predictions made by the control server about the user.

### BACKGROUND

Individuals, whether young or old, that attend colleges, universities, or other post-secondary educational institutions, generally require financial assistance in order to afford the substantial expenses associated therewith. In order to qualify for financial assistance, individuals are generally required to apply for and fill-out forms that determine the individual's need for financial assistance. Accordingly, the decision-makers, such as financial institutions or government sponsored organizations, will determine the need of each individual based on his or her current financial situation.

For instance, an individual who has substantial wealth, whether the wealth was materialized independently or from the individual's parent or spouse, may not qualify for any financial aid since the individual is capable of affording the post-secondary education himself or herself. Alternatively, some individuals may require financial assistance in order to attend a post-secondary educational institution. In this regard, in order to determine how much financial aid the individual actually needs based on his or her financial situation, various factors about the individual's life are taken into consideration. However, some individuals may not receive as much financial aid as they would like or otherwise need based on the formulas implemented by the decision-makers.

### SUMMARY

A system and method that analyzes an individual's financial situation, provides future projections or characteristics about the user, and provides recommendations to the user to maximize financial aid is disclosed herein. The system may provide a user with a proprietary questionnaire that provides questions relating to the life of the user. For example, the questionnaire may include inquiries regarding the user, his or her parents, and his or her spouse, if applicable. The questionnaire may inquire as to whether the individual or the individual's family are self-employed, their salaries, and other questions relating to the assets of the individual, the individual's spouse, or the individual's parents.

Based on the individual's answers to the questionnaire, the system determines one or more primary recommendations that are unique to the individual. For instance, the one or more primary recommendations may advise as to how the user can maximize financial aid.

Additionally, the system may provide a further recommendation based on secondary projections about the user based on personal factors or developments of the user and external factors unrelated to the user. For instance, the personal factors may include the career choice of the user, age, whether or not the individual is married, etc. The external factors may include current employment rate of the country or geographical region of the user, health of the overall economy, etc. The system may take into consideration the secondary projections when making the recommendations to the user. In addition, based on the secondary projections, future primary recommendations may be generated and transmitted to the user in addition to the original primary recommendations. The future primary recommendations may provide the individual with recommendations based on the financial situation of the individual in his or her subsequent years in the post-secondary institution, such as junior year or senior year. In this regard, the technology herein may also be used as a financial planning tool for the user.

Aspects of the technology as described above may be implemented via a method, the method includes displaying, using one or more processors, a series of questions relating to a current status of a user; receiving, using the one or more processors, answers from the user to the series of questions; determining, using the one or more processors, one or more primary recommendations based on the received answers, wherein the one or more primary recommendations advise the user how to increase the amount of financial assistance the user receives from a financial institution; and providing, using the one or more processors, the one or more primary recommendations to the user.

The method may further include the step of determining, using the one or more processors, secondary projections based on the received answers from the user, wherein the secondary projections are based on either personal developments of the user, external factors unrelated to the user, or both. As a further example, generating, using the one or more processors, future primary recommendations based on the secondary projections. As another example, the personal developments of the user include future events affecting a career or salary of the user, the effect of marriage on the user, the effect of re-location on the user, or the user having children. In a further example, the external factors include unemployment rate of a geographical region, lending rates, actuary data unique to the user, actuary data related to offspring of the user, or actuary data related to a spouse of the user. As another example, the external factors are updated in real-time, such that when the user inputs answers to the series of questions, the future primary recommendations are based on up-to-date information. As another example, the primary recommendations is based on whether or not one or more of the user, a spouse of the user, or a parent of the user is self-employed.

As another embodiment, a system in accordance with the present technology is disclosed herein. The system includes memory and one or more processors operatively coupled to the memory, and the one or more processors are configured to: display a series of questions relating to a current status of a user; receive answers from the user to the series of questions; determine one or more primary recommendations based on the received answers, wherein the one or more primary recommendations advise the user how to increase the amount of financial assistance the user receives from a financial institution; and provide the one or more primary recommendations to the user.

As a further example of the system, the one or more processors are further configured to determine secondary projections based on the received answers from the user, wherein the secondary projections are based on either personal developments of the user, external factors unrelated to the user, or both. As another example, the one or more processors are further configured to generate future primary recommendations based on the secondary projections. In another example, the personal developments of the user include future events affecting a career or salary of the user, the effect of marriage on the user, the effect of re-location on the user, or the user having children. In a further example, the external factors include unemployment rate of a geographical region, lending rates, actuary data unique to the user, actuary data related to offspring of the user, or actuary data related to a spouse of the user. In another example, the external factors are updated in real-time, such that when the user inputs answers to the series of questions, the future primary recommendations are based on up-to-date information. As another example, the primary recommendations is based on whether or not one or more of the user, a spouse of the user, or a parent of the user is self-employed.

As a further embodiment and in accordance with the present technology, a non-transitory, tangible machine readable medium on which instructions are stored, the instructions, when executed by a processor cause the processor to perform a method, is disclosed herein. In that regard, the method includes displaying a series of questions relating to a current status of a user; receiving answers from the user to the series of questions; determining one or more primary recommendations based on the received answers, wherein the one or more primary recommendations advise the user how to increase the amount of financial assistance the user receives from a financial institution; and providing the one or more primary recommendations to the user.

As a further example of the computer-readable medium, the method also includes determining secondary projections based on the received answers from the user, wherein the secondary projections are based on either personal developments of the user, external factors unrelated to the user, or both. As a further example, the method includes generating future primary recommendations based on the secondary projections. In another example, the personal developments of the user include future events affecting a career or salary of the user, the effect of marriage on the user, the effect of re-location on the user, or the user having children. As another example, the external factors include unemployment rate of a geographical region, lending rates, actuary data unique to the user, actuary data related to offspring of the user, or actuary data related to a spouse of the user. As a further example, the external factors are updated in real-time, such that when the user inputs answers to the series of questions, the future primary recommendations are based on up-to-date information.

### BRIEF DESCRIPTION OF THE DRAWINGS

FIG. 1 is an example system in accordance with aspects of the present disclosure.

FIG. 2 depicts exemplary devices of the system in FIG. 1 in accordance with aspects of the present disclosure.

FIG. 3 illustrates an exemplary questionnaire in accordance with aspects of the present disclosure.

FIG. 4 illustrates a control server processing information received by a client computing device in accordance with aspects of the present disclosure.

FIG. 5 depicts exemplary points of an individual's life in accordance with aspects of the present disclosure.

FIG. 6 is a flow chart in accordance with aspects of the present disclosure.

### DETAILED DESCRIPTION

The aspects, features and advantages of the present disclosure will be appreciated when considered with reference to the following description of preferred embodiments and accompanying figures. The following description does not limit the disclosure; rather, the scope is defined by the appended claims and equivalents. While certain processes in accordance with example embodiments are shown in the figures as occurring in a linear fashion, this is not a requirement unless expressly stated herein. Different processes may be performed in a different order or concurrently.

The present disclosure describes a system and method that analyzes, processes, and predicts financial information about a user, and provides recommendations to the user based on the financial information. For example, an individual that wishes to attend a post-secondary educational institution may require financial aid from a financial institution. Since the amount of financial aid the individual is able to receive is based on need, the present system and method may analyze a current financial status or situation of an individual, predict certain projections, events, or otherwise characteristics about the financial future of the individual, and provide recommendations to the user in order to maximize the amount of financial aid he or she can receive from the financial aid institution. In this regard, the system may provide the individual with a questionnaire, and based on the individual's answers to the questionnaire the system may provide the individual with recommendations as to methods in which he or she can maximize the amount of financial aid he or she can receive. These recommendations may take into account whether the individual's personal wealth, and also secondary characteristics such as the marital status of the individual, the chosen career path of the individual, etc.

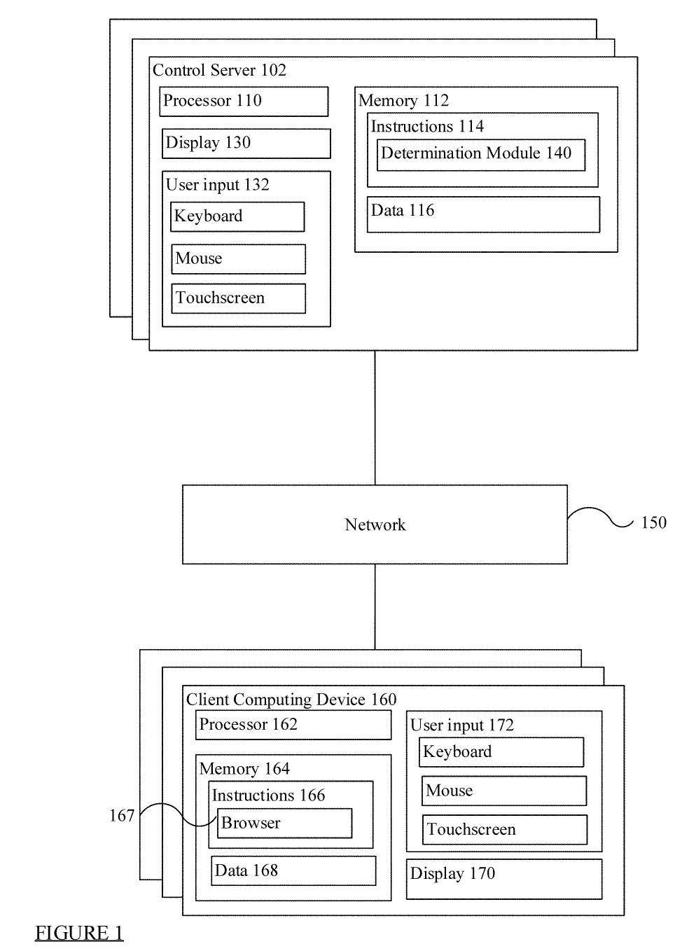

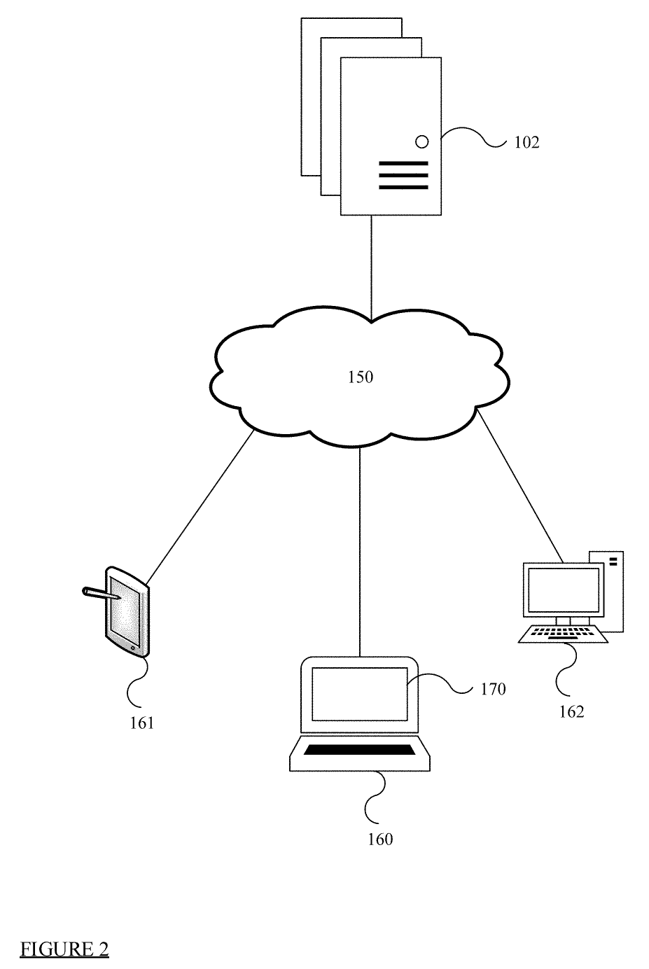

FIGS. 1 and 2 include example systems in which the features described above may be implemented. It should not be considered as limiting the scope of the disclosure or usefulness of the features described herein. In this example, the system can include control server 102 and computing devices 160-162. Control server 102 and each of the computing devices 160-162 can contain one or more processors, memory and other components typically present in computing devices.

Memory 112 can include data 116 that can be retrieved, manipulated or stored by processor 110. Memory 112 can be of any non-transitory type capable of storing information accessible by processor 110, such as a hard-drive, memory card, ROM, RAM, DVD, CD-ROM, write-capable, and read-only memories.

Instructions 114 can be any set of instructions to be executed directly, such as machine code, or indirectly, such as scripts, by processor 110. In that regard, the terms “instructions,” “application,” “steps” and “programs” can be used interchangeably herein. Instructions 114 can be stored in object code format for direct processing by the processor, or in any other computing device language including scripts or collections of independent source code modules that are interpreted on demand or compiled in advance. Functions, methods and routines of the instructions are explained in more detail below. Furthermore, instructions 112 includes determination module 140 which includes a set of proprietary instructions that are accessed and executed by processor 102, as described in more detail below.

Data 116 can be retrieved, stored or modified by processor 110 in accordance with the instructions 114. For instance, although the subject matter described herein is not limited by any particular data structure, data 116 can be stored in computer registers, in a relational database as a table having many different fields and records, or XML documents. The data can also be formatted in any computing device-readable format such as, but not limited to, binary values, ASCII or Unicode. Moreover, data 116 can comprise any information sufficient to identify the relevant information, such as numbers, descriptive text, proprietary codes, pointers, references to data stored in other memories such as at other network locations, or information that is used by a function to calculate the relevant data.

Referring to FIGS. 1 and 2, data 116 can include database 118 to store various information. Although database 118 is illustrated as being within the same housing as control server 102, database 118 may be remote from control server 102. For instance, database 118 and control server 102 may be connected over network 150. Network 150 may be a Personal Area Network, Local Area Network, Wide Area Network, or the Internet. Control server 102 can have the capability to read, write, and access data on database 118. Furthermore, database 118, control server 102, or both may operate using expandable cloud storage capabilities. In this regard, whether control server 102 or simply database 118 is stored in cloud-based storage, a user may use any computing device, such as a laptop, personal computer, Smartphone, tablet, etc. to access and manipulate the contents in database 118 and control server 102.

Processor 110 can be any conventional processor, such as a commercially available CPU manufactured by, for example, Intel®, Advanced Micro Devices®, etc. Alternatively, processor 110 can be a dedicated component such as an ASIC or other hardware-based processor.

Although not necessary, control server 102 may include specialized hardware components to perform specific computing processes, such as decoding video.

Control server 102 can include display 130 (e.g., a monitor having a screen, a touchscreen, a projector, a television, or other device that is operable to display information), and user input 132. User input 132 may include, for example, a keyboard, mouse, and touchscreen. Other input devices are also possible, such as a microphone. In this regard, control server 102 may include only one or a plurality of the various input devices.

Computing device 160 may also include a processor 162, memory 164, instructions 166, data 168, user input 172, and display 170, all of which may perform similarly as discussed above with respect to the processor 110, memory 112, instructions 114, data 116, user input 132, and display 130 of control server 102, respectively. In this regard, for example, client computing device 160 may include user input 172 such as a keyboard, mouse, touchscreen, and any other input device such as a microphone. In addition, client computing device 160 includes a browser 167 in instructions 166 of memory 164, which may be used to access a particular Uniform Resource Locator (“URL”) to access a website, as discussed in more detail below. Although not shown, with respect to client computing devices 161 and 162 in FIG. 2, these client computing devices also include a processor, memory, a display, various input devices, GPS etc. and overall may be constructed and configured to operate similarly to client computing device 160 as discussed above.

Although FIG. 1 functionally illustrates processor 110, memory 112, and other elements of the control server 102 as being within the same block, processors, memory, control server, displays, etc. can actually comprise multiple processors, memories, control servers, displays, etc. that may or may not be stored within the same physical housing. For example, memory 112 can be a hard disk drive, solid state drive, or other storage media located in a housing different from that of control server 102. Accordingly, references to a processor, memory, computer, control server, etc. will be understood to include references to a collection of processors, memories, computers, control servers, etc. that may or may not operate in parallel. For example, control server 102 may include a single server computing device or a load-balanced server farm. And although some functions described below are indicated as taking place on a single computing device having a single processor, various aspects of the subject matter described herein can be implemented by a plurality of computing devices, for example, communicating information over network 150.

Similarly, processor 162 and memory 164 of client computing device 160 may be contained within the same housing or operate remotely from each other, and may include a plurality of components therein. For instance, processor 162, memory 164, and other components of client computing device 160 may be a plurality of processors, memories, etc., and should not be restricted to a single or particular type of processor or memory. Further, information collected on client computing device 160 may store temporarily in memory 164 (such as in Random Access Memory or on an internal hard drive) and be transmitted over network 150 to a remote database (not shown) in a hard drive, or alternatively transmitted directly to database 118 of control server 102. If, for example, data is stored in a distinct database remote from client computing device 150 and control server 102, the data may subsequently be accessible by control server 102. Client computing devices 161 and 162 are also configured similarly to client computing device 150.

Although client computing devices 160-162 may each comprise a full-sized personal computing device, they may alternatively comprise mobile computing devices capable of wirelessly exchanging data with each other or control server 102, such as via network 150. FIG. 2 illustrates exemplary computing devices of control server 102 and client computing devices 160-162. By way of example only, client computing devices 160-162 may be a mobile phone (e.g., Smartphone) or a device such as a wireless-enabled PDA, a tablet, a laptop, head-mountable device, Smart watch, or a netbook that is capable of obtaining and transmitting information via the Internet.

Control server 102 and computing devices 160-162 can be at nodes of network 150 and capable of directly and indirectly communicating with other nodes of network 150. Although only a few computing devices are depicted in FIGS. 1-2, it should be appreciated that a typical system can include a large number of computing devices, with each different computing device being at a different node of the network 170. The network 150 and intervening nodes described herein can be interconnected using various protocols and systems, such that the network can be part of the Internet, World Wide Web, specific intranets, Wide Area Networks, or Local Area Networks. Network 150 can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, one or more computing devices 160-162 may include a web server that is capable of communicating with control server 102 as well as other computing devices 160-162 via network 150. For example, a user or administrator of control server 102 may use network 150 to transmit and present information to the user of computing device 160. Similarly, the users of client computing devices 160-162 may use network 150 to communicate with such as upload and transmit information to control server 102 that the user or administrator can view via display 130.

A prospective student that wishes to attend a post-secondary institution often requires financial assistance in order to pay for the various and significant costs associated with the given institution. These costs may include room and board, tuition, textbooks, a laptop or other computing device, and personal every-day expenses such as food, clothing, etc. The total cost of attending the post-secondary institution may be collectively referred to as the Estimated Cost Of Attendance (“ECOA”). The ECOA may amount in the tens or hundreds of thousands of dollars per each individual, depending on the particular college or university selected by the individual. These costs may increase even further if the individual decides to apply for a doctorate degree.

As a result of the substantial expenses associated with post-secondary education, in order to receive financial assistance from a financial institution or a government sponsored institution, individuals are often required to submit financial information about the current financial situation of the user or individual. This information may be submitted to a governmental organization or financial institution, such as by completing the Free Application for Federal Student Aid (“FAFSA™”) form. The FAFSA form takes into consideration various financial information about the individual, the individual's spouse, and the individual's parents, and then determines how much financial aid the individual needs. In this regard, it is assumed that the individual's parents or spouse will provide financial aid to the individual if one or more of them are wealthy. Accordingly, the individual's current financial status includes the individual's financial status, the individual's parents' financial status, and the individual's spouse's financial status. The amount of money that the individual is expected to receive from his or her parents or spouse is referred to collectively as the Expected Family Contribution (“EFC”).

For instance, if the individual, his or her spouse, or parents are wealthy beyond the average student, then that individual may not be able to receive much, if any, financial aid. Alternatively, if the individual, his or her spouse, or parents are not wealthy and thereby incapable of contemporaneously paying the post-secondary costs while in school, then a significant financial aid package may be necessary and thereby offered to that individual.

In order to maximize the amount of money the individual is able to receive, the individual may utilize the system and method disclosed herein. For instance, a user may use client computing device 160 to access a proprietary website via the World Wide Web. The user may use a web browser and user input 172, such as the keyboard, in order to input into the web browser and access a particular Uniform Resource Locator (“URL”) that is associated with and controlled by control server 102. In this regard, the various information and data located on the proprietary website may be stored on control server 102 or another server in communication with control server 102 over network 150.

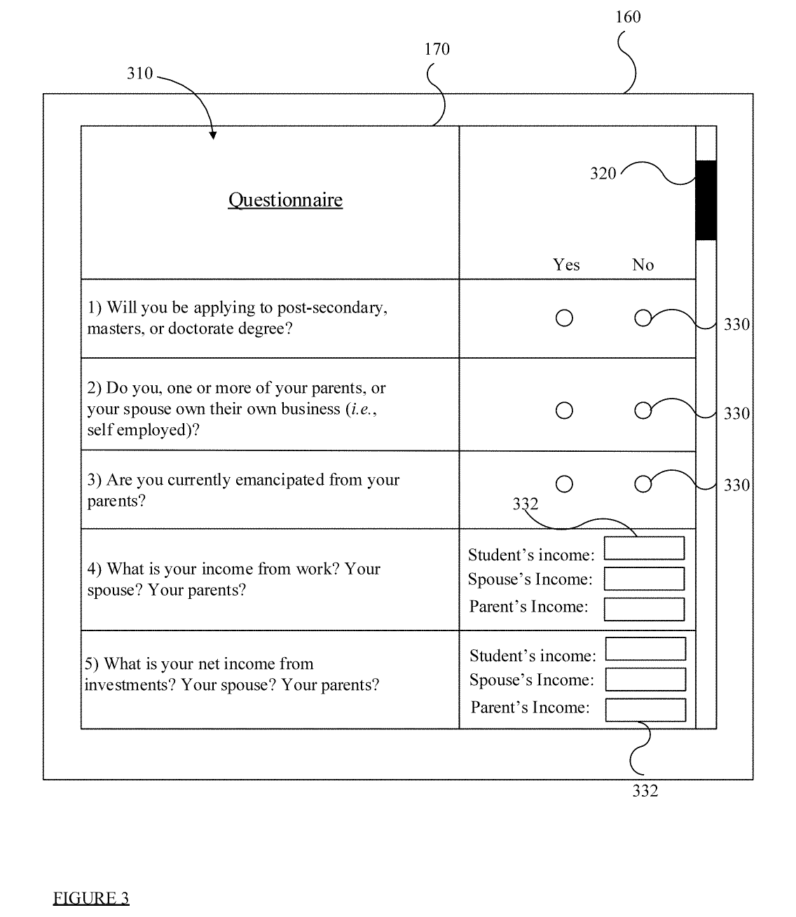

As illustrated in FIG. 3, upon accessing the proprietary website questionnaire 310 may be transmitted to client computing device 160 and displayed on display 170. Questionnaire 310 may be a series of questions tailored to elicit information about the individual's current financial status and, in particular, the EFC of the individual as described above. It should be understood that although questionnaire 310 is described as being accessible via the proprietary website, questionnaire 310 may alternatively be downloaded via a form, such as in Portable Document Format (“PDF”) or in a word processing document. As a further example or alternative, questionnaire 310 may be transmitted to the user via audible means, such as a pre-recorded audible version of each question in the questionnaire. As another example, an employee or other individual associated with control server 102 may vocally converse with the individual.

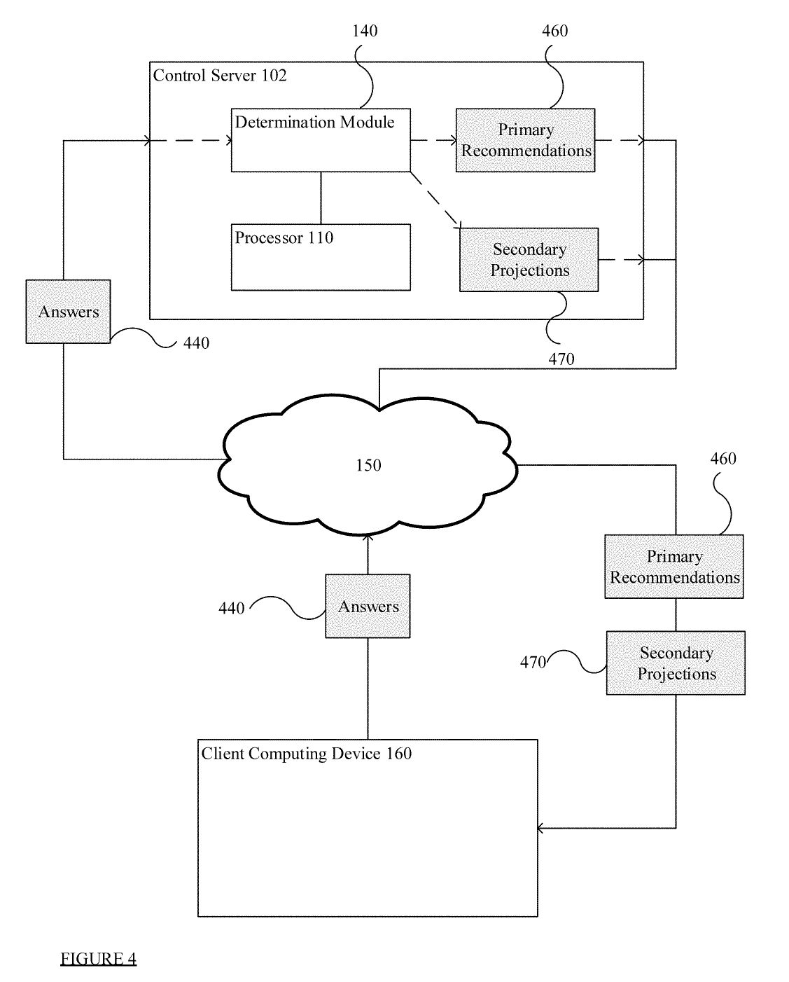

As shown in FIG. 3, initially the questionnaire verifies that the individual is applying for post-secondary education. From here, the questionnaire asks questions such as whether the individual is emancipated from his or her parents, the income from work and net income from investments by the individual, his or her spouse, and his or her parents. The individual may provide answers to these various questions using any number of user input 172, such as by clicking radio buttons 330 or entering text into text boxes 332. It should be understood that the questions illustrated in FIG. 3 are exemplary, and any number of questions may be asked, such as by the individual scrolling down the questionnaire using scroll bar 320. For example, additional questions may include the amount of cash the individual has in his or her saving and checking account, the number of family members of the individual currently attending college at least half time, the Adjusted Gross Income (“AGI”) on the tax return of the individual last year, etc. Other income from investments or other means with respect to the individual, the individual's parents, or the individual's spouse may be used as well, such as inheritance, other investment returns (e.g., stocks, bonds), gambling winnings or losses, and other unexpected windfalls. As shown in FIG. 4, once the user of client computing device 160 completes questionnaire 310, answers 440 are transmitted over network 150 to control server 102. In this regard, upon receipt of information from control server 102 and after the initial processing and storing of answers 440 into memory 112 (whether temporary memory, permanent memory, or a combination thereof), processor 102 in communication with determination module 140 may execute instructions to analyze answers 440. In this regard and as discussed in further detail below, determination module 140 may output primary recommendations 460 that are unique to that particular user and his or her current life situation or financial situation. In addition, determination module 140 may also output secondary projections 470 that are likewise unique to the individual user based on his or her current life situation or financial information. Furthermore, based on secondary projections 470 determined and output by determination module 140, future primary recommendations may be determined accordingly based on secondary projections 470, as discussed in further detail below. In this regard and as described in further detail below, it should be understood that any of the information taken into consideration to determine primary recommendations or secondary projections may be used interchangeably. That is, any of the information discussed below with respect to the secondary projections may also be used to determine the primary recommendations, and vice versa.

Referring first to primary recommendations 460, by way of example only, one primary recommendation 460 may be to advise the individual, the individual's spouse, or the individual's parents to transfer money into an annuity account. In this regard, when the finances are transferred into an annuity account then this money may not be considered by FAFSA or other similar organization when determining the EFC of the individual. As another example, the primary recommendation 460 from control server 102 may include advising the individual to purchase a universal life insurance policy or a whole life insurance policy. In this regard, when a universal life insurance policy or whole life insurance policy are purchased, the costs associated therewith may similarly not be considered as money toward the EFC of the individual. Therefore, primary recommendations 460 made by control server 102 to the individual reduces the EFC of the individual, thereby increasing the amount of need that is ultimately determined for and associated with the individual. For example, since EFC is subtracted from the ECOA for the particular individual, by the EFC being reduced the overall need will thereby be increased. Accordingly, the amount of money that the individual requires, and will receive, from the given financial institution to finance his or her post-secondary education increases.

As a further example, other primary recommendations 460 made to the individual may be for the individual, the individual's spouse, or the individual's parents to purchase a 409 Nonqualified Deferred Compensation Plan (“409 Plan”). By purchasing the 409 Plan, this may reduce both income and assets for the parents, thereby again reducing the individual's EFC. As another example, the primary recommendation may be to invest in a self-owned business for families where any one or more of the parents, the individual, or the individual's spouse own their own business. It should be understood that any number of primary recommendations 460 may be generated by determination module 140 and transmitted to client computing device 160, such as one primary recommendation, two primary recommendations, etc. In this regard and as mentioned above, the recommendations provided are unique to each user based on the individual user and his or her answers to questionnaire 310. For example, primary recommendations 460 are configured based on proprietary software that has been developed to provide the best possible recommendation to the individual.

In addition to the above primary recommendations, control server 102 may also determine secondary projections concerning the individual that allows the user to plan his or her financial future and prepare for subsequent years. For example, questionnaire 310 described above may include one or more secondary questions that are tailored to uncovering information related to personal factors or developments of the user that is calculated and predicted to occur. For example, secondary questions may be personal questions about the individual himself or herself. It should be understood that the primary and secondary questions contained in questionnaire 310 may overlap with each other and thereby be used to form primary recommendations, secondary projections, and combinations thereof. For instance, questions pertaining to the current income of the individual may be used to make primary recommendations and secondary projections.

As an example, the secondary questions may include questions about the career of the individual, such as his or her current employer, income, and location of employment. By understanding the overall employment information of the user, determination module 140 is able to make proprietary decisions as to the likely progression of income in that particular career based on the age of the individual, years of experience in that career, likelihood of quitting or being laid off, likelihood of receiving a promotion, likelihood of re-location, etc. Furthermore, determination module 140 may consider that when an individual receives a promotion that this limits the individual's likelihood of geographic mobility in the future. As a further example, other factors determination module may consider are the ramifications of moving for employment reasons, and the increased or decreased risk of loss of employment based on various factors, such as the type of employment, years of experience, geographic location, etc.

Additionally, based on the answers in response to the primary questions, secondary questions, or a combination thereof, determination module 140 may use asset and investment information to determine future assets of the user. For instance, based on market performance, the amount of money the individual or the individual's family has in various investment accounts, determination module 140 may determine the value or approximate or projected value of the accounts the future, e.g., days, months, years, etc. Furthermore, other investment information that may be taken into consideration includes inheritance, gambling winnings or losses, and other financial windfalls. As another example, a variance of the value of assets of the individual's, individual's parents, or the individual's spouse may be taken into consideration by determination module 140. For instance, current home equity or other land owned, and other investments of the individual, the individual's spouse, or the individual's parents.

As another example, determination module 140 may consider the amount of education of the individual. For example, if the individual already earned a bachelor's degree and is thereby going back to school for a doctorate, the current level of education and the expected education that the individual wishes to attain may be considered in terms of how income will be affected, job stability, and career stability. For instance, an individual with more education may have greater job stability and generally higher projected income than an individual with a bachelor's degree or high school education.

Determination module 140 may further consider the likelihood need for a car for the individual in the future. For example, if the individual is in a suburban or rural area, then it is likely the individual may be purchasing a vehicle in the future. In this scenario, determination module 140 may consider an expected down payment that will be put down on the car, expected monthly payments, duration of monthly payments, owning versus leasing the vehicle, expenses associated with owning a vehicle such as maintenance and insurance, and the turnover rate. As a further example, if the individual lives in an urban area then determination module may instead calculate the cost of taking public transportation instead of the expenses associated with owning or leasing a vehicle.

As a further example, determination module 140 may factor in expenses associated with purchasing a home in the future. For example, determination module 140 may consider location, mortgage programs, potential for re-location, and statistical size variances based on income, marriage, children, and inheritance. With respect to re-location of the individual, determination module 140 may consider factors such as where the individual is attending post-secondary education, where the individual was born and raised, the career path of the individual, and any number of factors to determine the likelihood of re-location. Furthermore, if re-location is predicted to occur then determination module may take into account the cost or cost-savings associated with moving to the particular location, such as consumer price index, property taxes in the area, etc.

Determination module 140 may also consider vacations that the individual and his or her family are likely to go on and expenses associated therewith. For example, if the individual has a relatively high income, then determination module may take into account that the individual spends a commensurate amount of money on vacations, including air travel, hotel costs, longer duration of vacation, and the cost of timeshares, shore houses, etc.

As another example, determination module 140 may take into account the amount of money the individual, the individual's spouse, and the individual's parents invest in a retirement fund. In this regard, determination module 140 may be configured to consider whether the individual is single or married, financial expectations of the individual based on his chosen career path, cost of retirement home expenses, end of life decisions such as funeral costs, potential legal fees associated with probate or other post-life legal altercations, etc. If the individual owns his or her own business, then determination module 140 may consider future successors to the business, such as children or other related family members to the business.

As another example, determination module 140 may consider the effects of marriage on the finances of the individual. For example, marriage may affect the potential of re-location of the individual, the overall income of the individual based on having a second income from his or her spouse or if the spouse does not work then subtracting from the individual's overall income. Additionally, by getting married the likelihood of having children may increase, which thereby affects various other expenses associated with the individual. For instance, if the individual has children then determination module 140 may consider all expenses effected thereby, such as the need for a larger home or larger vehicle, college savings for the one or more children, schooling for the children such as private, public, or home schooling, and future wedding decisions.

Additional examples of factors that may be considered by determination module 140 include the movement of assets from one class to another, such as moving funds from liquid to equity in a business, auto, home, etc. In addition, liabilities incurred by the individual, the individual's spouse, or the individual's parents may be considered, such as the presence of lawsuits. In addition, insurance coverage as an expense may be considered, such as the presence of auto insurance, home insurance, health insurance, and life insurance. As a further example, the quality of credit may be taken into consideration, both present and future recommendations.

By taking into consideration one, some, or all of the factors discussed above, control server 102 is able to get a complete picture of the individual user and thereby calculate and generate quality recommendations to the individual user.

The individual may also be able to make changes that effect the decisions and predictions made by determination module 140. For example, if the individual does not want to get married or have children in the future, then these are decisions that the individual can bypass by inputting such information into questionnaire 310. For instance, the individual may input that he or she does not plan on having any children. By doing so, the calculations, determinations, and predictions made by determination module 140 may change thereby. For example, instead of predicting that the individual will be purchasing a larger and more expensive vehicle in the future as a result of having children, determination module 140 may instead predict that the individual will be investing money into a mutual fund, savings account, larger home, or other investment. In addition, any other various expenses associated with having children will thereby be transferred into an overall greater wealth of the individual. Similarly, if the individual indicates to control server 102 that he or she does not plan on applying for promotions and will be content with a certain salary, then any secondary projections with respect to increased earnings over time may likewise not be calculated.

As a further example, the individual may input that he or she wishes to set aside a certain percentage or specific number for charity, car purchase, house purchase, etc. In this regard, the system will fix these variables accordingly, and thereby adjust the primary recommendations and/or secondary projections. Furthermore and in this regard, the credit score of the individual—and perhaps the projected credit score based on previous occurrences reflected in the individual's credit report, may affect the overall costs, interest rates, etc. that may be expected to occur based when applying for the respective loans. For instance, based on a lower credit score and having real-time up-to-date information as to the current market mortgage rate, control server 102 is able to calculate and generate the likely costs that the individual can expect, along with the likely timing the individual will be able to make the purchase, etc. In this regard, all of this information may also be used in making the current primary recommendations and the future primary recommendations.

In addition to secondary projections 470 being based off of personal factors or developments of the user, the secondary projections may also include external factors unrelated to the individual. As one example, an external factor may include the current state of the economy, such as whether or not the U.S. or world is in a recession or not. As another example, an external factor may include the unemployment rate of the U.S. economy, the state the individual is located in, and even the geographic region that the individual is located in. In this scenario, determination module 140 may also take into account the particular job that the individual has, and consider the job outlook in the given field. Other external factors may include lending rates such as for purchasing a house or vehicle, and actuary data such as life expectancy of the individual, the individual's spouse, and the individual's children. These various external factors may be updated in real-time such as by being linked up to a particular source or using proprietary software. For example, control server 102 may be linked up to a source, such as another server that may be remote from control server 102, that automatically updates the unemployment rate throughout the country and within the geographic location of the individual. In this regard, by having current and up-to-date information, control server 102 becomes more intelligent and thereby able to make better predictions, overall decisions and primary recommendations for the individual.

In addition, determination module 140 may take into account historical data about various secondary factors as well. For example, historical data about a particular profession can aid in the prediction of salary increases for a particular profession. For instance, historical data about a lawyer may indicate that the salary at the beginning of a new attorney's career is below average, and then after a certain amount of years of experience the salary of the attorney increases. Conversely, the salary of a hairdresser may start out at a certain salary, grow as the hairdresser gains experience, and then ultimately hit a ceiling where the salary becomes stagnant across the profession. Determination module 140 may make predictions for any secondary projection in addition to career, such as historical data related to typical age of marriage (such as in that geographical region), typical age to have children, typical age of retirement, etc. As discussed above, however, the individual may modify any factor that is predicted for the user, such as inputting that he or she will not retire until a certain age, such as 68, in which case the secondary projections made by determination module 140 may adapt accordingly.

The above considerations, decisions, and predictions taken into account by determination module 140 may interrelate and ultimately affect each other. For example, if the individual is married and has children then that would likewise affect the cost of vacations, the likely cost of the vehicle that is purchased, the size and location of the home that is purchased, and the likelihood the individual will receive a promotion or salary increase. As another example, the likelihood of receiving a promotion may affect other aspects of the decision making performed by determination module 140 as well, such as increasing career risk or even affecting actuary tables. For instance, the individual may have a large commute time, less exercise time, and thereby a shorter life span, etc., which would ultimately increase the net income for savings since the individual is projected to pass away earlier.

Based on the above information, determinations, and predictions executed by determination module 140, the system is able to predict future primary recommendations to the user. For instance, if the individual, the individual's spouse, or the individual's parents have various investment accounts that increase every year, then in a four-year institution the EFC of the individual will thereby increase as well by virtue of the increased financial earnings from investments. In this regard, not only can determination module make current year primary recommendations to the user, as illustrated in FIG. 4, but determination module 140 may make future primary recommendations to the user based on the secondary projections. The secondary projections are based on some or all of the criteria described above, including the personal factors of the individual and external factors unrelated to the individual. For example, secondary projections may be based on marriage, the presence of children, vacation expenses, retirement expenses, income and job growth, vehicle purchases, etc. Either one or both of the personal developments of the user and external factors unrelated to the user may affect the secondary projections that are ultimately output by determination module 140 and control server 102.

In this regard, if determination module 140 predicts that the individual will get married while still attending the post-secondary institution, then the future primary recommendation will be based on the effects of the predicted marriage. For instance, if the individual gets married in his or her second year in post-secondary education, then this effects the overall calculations of the EFC and accordingly determination module 140 has to thereby adjust the primary recommendations from prior years. As another example, if determination module 140 determines that the individual already has children and may be purchasing a larger and more expensive vehicle or house as a result, then determination module 140 will likely not recommend for the individual to move money into an annuity or whole life insurance plan, since the individual will likely require the available funds for child-rearing costs.

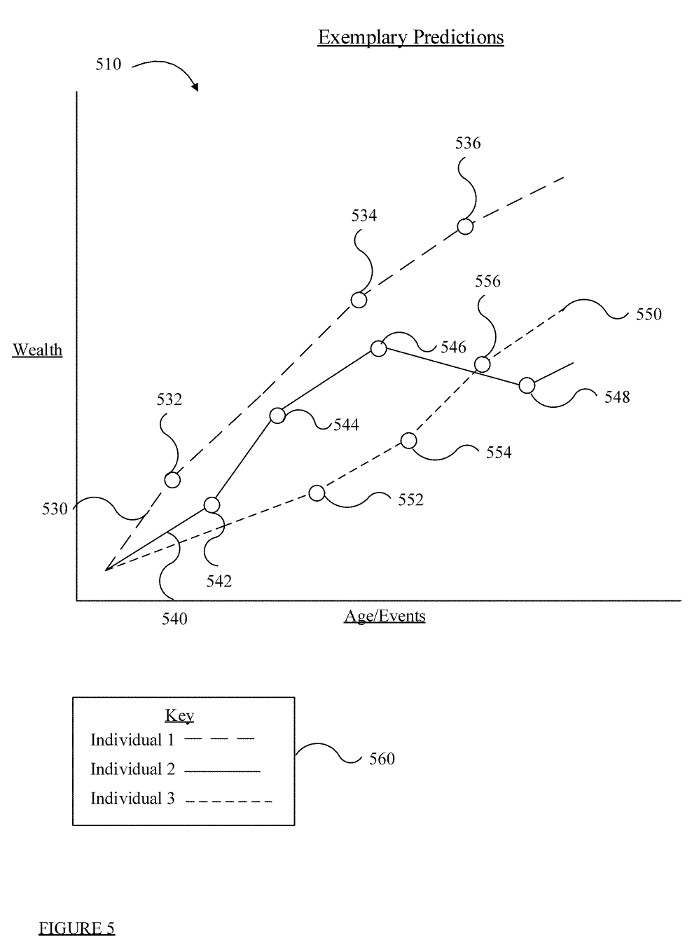

Based on the above information and determinations executed by determination module 140, FIG. 5 depicts an exemplary graph 510 with three different individuals and how various events affect the finances of the respective individual. In this scenario and as another implementation of the present disclosure, the secondary projections that are made via determination module 140 described above may be used as a personal financial aid tool as well. The graph depicted in FIG. 5 may represent predictions by determination module 140 based on when the individual accessed questionnaire 310 and the overall system and method herein. In this regard, FIG. 5 and all points therein represent predictions by determination module 140 with respect to each individual's life as represented in key 560.

For instance, referring to Individual 1 represented by dashed line 530 as indicated by key 560, Individual 1 went to college at point 532, received higher earnings thereafter, and then received two promotions at points 534 and 536. In this example, Individual 1 indicated to control server 102 (such as via questionnaire 310) that he or she did not get married or have children, thereby having more time to work, receive promotions, etc.

Conversely, Individual 2 as represented by solid line 540 went through several events that affected the overall projections output by determination module 140. For example, at point 542 Individual 2 went to college and thereafter received a higher salary. From here, Individual 2 got married at point 544 where the wealth of Individual 2 continued to increase but at a slower rate. In this regard, determination module 140 may have determined that based on the personal factors, personal developments, and external factors associated with Individual 2, that after marriage the income of Individual 2 would not simply double based on marriage. From here, Individual 2 had children at point 546, where the wealth of Individual 2 decreased as a result due to the expenses therefor. Finally, at point 548 Individual 2 began increasing wealth again due to the children getting older and Individual 2 being able to work more.

Individual 3 represented by the dashed and dotted line 550, at point 552 Individual 3 got married, and based on the salary of the spouse of Individual 3 his or her wealth increased. At point 554, Individual 3 received a promotion which increased his or her salary rather significantly due to the career path that Individual 3 entered. From here, at point 556 Individual 3 had children and accordingly his or her wealth slightly reduced.

Although the description of FIG. 5 above provides specific examples, it should be understood that any number of events could have occurred or been predicted to occur within each of the lives of the individuals, and thereby affect the financial wealth of the individual. For instance, each point described above is exemplary only and is used to provide an example of how determination module 140 generates the secondary projections and future primary recommendations. In addition, it should be understood that the wealth and timeframe shown on the y axis and x axis, respectively, may not be the same for each of Individual 1, Individual 2, and Individual 3. Rather, the wealth and timespan for each individual is unique to each individual, and graph 510 is exemplary only. As a further example, any of the individual points depicted in FIG. 5 may be attributed to any of the factors discussed above with respect to how primary recommendations, future primary recommendations, and secondary projections are generated. This includes the location of employment, real-time data updating the mortgage rates (whether nationally or local to the individual), the receipt of a windfall from gambling or inheritance, etc.

Based on the above predictions made by determination module 140, determination module 140 is capable of making better and smarter recommendations to the individual. For instance, at the various points represented in FIG. 5, whether the respective individual is attending post-secondary education or not, the system and method herein may be a useful financial planning tool. As one example, with respect to Individual 2, since Individual 2 is expected to have a decrease in wealth as a result of having children at point 546, determination module 140 is able to predict that the EFC of the individual will be reduced, assuming Individual 2 is attending post-secondary education at that time. As a result of the EFC of Individual 2 decreasing at those points in his or her life, Individual 2 can expect to receive more financial aid since his or her overall need has increased. Conversely, Individual 3 has an increased wealth at virtually all points in his or her life as a result of the career path that the individual chose. As a result, the primary recommendation made by determination module 140 may be that the user transfer money into an annuity in order to reduce the EFC of the individual, and thereby increase the overall need for financial aid purposes.

The system and method described herein may not only be used to provide recommendations to reduce the EFC of the individual, but if the individual wishes to plan for his or her financial future, the individual is no longer attending school, or the individual does not even plan on attending post-secondary education, then the system and method herein may also be used as a financial planning tool. For example, using all of the various factors above, control server 102 is able to indicate to the user how much money they can anticipate to need at various points in his or her life, whether short term or long term. Depending on the situation, short-term may be several days, months, or even years, and long-term may be several weeks, months, years, or decades in the future. For instance, as discussed above control server 102 may assume that the user will go on vacation once a year, purchase a vehicle with a five-year loan, purchase a second or larger vehicle when the system predicts—or is informed by the user, that the user will have children, and predict that the user receives a raise and/or promotion at his or her place of employment. Taking into consideration all of these factors, control server 102 may adjust or otherwise change its recommendation throughout the next several years of the user's life. Control server 102 may recommend a more lavish vacation when the user is single, and then a more economical vacation when the user is married with children. Likewise, when the user has children control server 102 may predict that a larger vehicle or second vehicle is necessary as a result. Also, by understanding the likelihood that the user will receive a raise or promotion (based on the user's field of employment, geographical region, etc. as discussed above), control server 102 may adjust its ultimate recommendation in terms of how much money the user should invest, how much more expensive of a vacation the user can take based on the increased salary, etc. Accordingly, by control server 102 being configured to predict, re-calculate, and then adjust the various predictions and recommendations based on the individual and unique to the user, control server 102 is thereby configured to be an artificially intelligent device and planning tool.

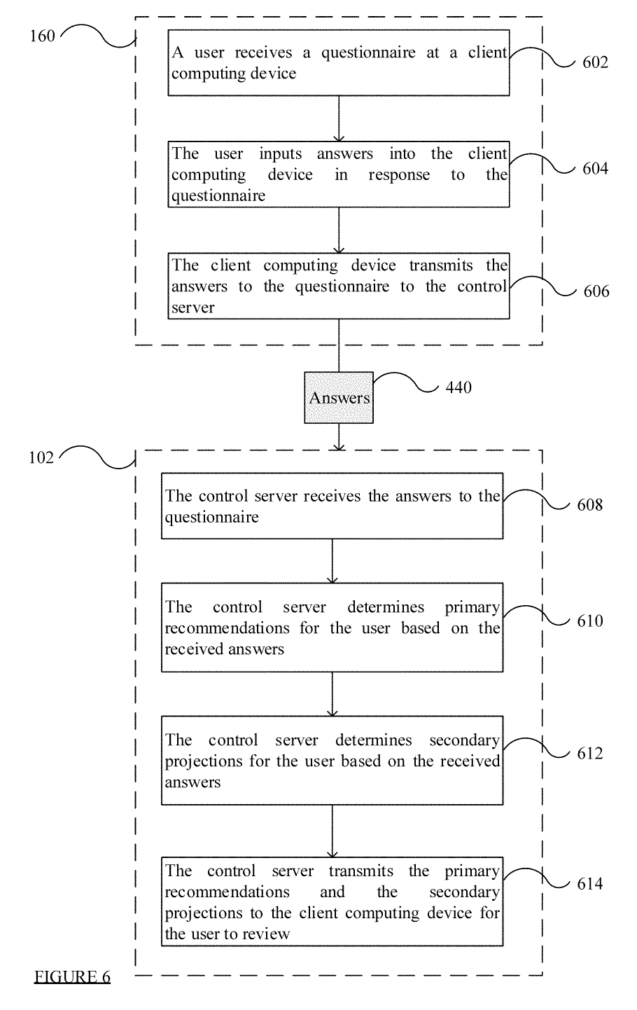

FIG. 6 provides an exemplary flowchart of the system and method disclosed herein. At step 602, client computing device 160 receives a questionnaire. At step 604, client computing device 160 inputs answers in response to the questionnaire. At step 608, client computing device 160 transmits answers 440, such as to control server 102. At step 608, control server 102 receives answers 440 to the questionnaire. Based on the received answers 440, at step 610 control server 102 determines primary recommendations that are unique to the user. At step 612 control server 102 determines secondary projections based on answers 440. At step 614, control server 102 transmits the primary recommendations and the secondary projections to the user. In this regard, it should be understood that control server 102 may or may not determine secondary projections for the user and may only determine and transmit primary recommendations. In addition, if control server 102 does determine secondary projections based on answers 440, then control server 102 may also determine and transmit future primary recommendations unique to the user based on the determined secondary projections. As a further example, if the user downloaded or otherwise installed software locally, such as in memory of client computing device 160, then answers 440 may simply be processed locally, such as processor 162 and the determination module 140 which is stored locally in memory 164 of client computing device 160.

Although the above describes the user accessing a proprietary website in order to access questionnaire 310 and input the pertinent information accordingly, it should be understood that the individual may access information described above through other means as well. For example, the individual may access questionnaire 310 by downloading or installing software onto their personal computer or otherwise computing device. In this regard, by downloading or installing the software on the computing device of the individual, then the software may include in memory determination module 140 which thereby provides the user the ability to use his or her own computing device to perform the above calculations, such as primary recommendations, secondary projections, etc.

It should be understood that the disclosure herein may be used for any number of individuals and at any point within the respective life of the individual. For instance, the system described herein may be used for an individual going from secondary to post-secondary education, for an individual who has been working for several years, for an individual departing from the armed forces, etc. In this regard, the fluid and real-time updates of the system described above is able to take into consideration the life of the particular individual, and make decisions and recommendations based thereon.

Furthermore and as already discussed above, the various factors and information that the determination module takes into consideration for the primary recommendations and secondary are interchangeable. For instance, if one of the factors is discussed with respect to determining primary recommendations, that factor may also be used for determining secondary projections. Likewise, if a factor is discussed with respect to determining secondary projections, then that factor may also be used for determining primary recommendations. As one example, variances of various investments of the individual, the individual's spouse, or the individual's parents, such as with respect to home equity, was discussed with respect to the secondary projections. However, the current home equity may also be useful in determining the primary recommendations as well.

Advantages of the foregoing include a analyzing a current financial status of an individual and his related family, predicting future financial projections about the individual and his family's financial status, and provide recommendations to the individual accordingly. For instance, by understanding the individual's financial status, the present disclosure is able to recommend actions to take to the individual in order to minimize the EFC of the individual and thereby maximize need. Even further, the information control server uses to provide the primary recommendations may be updated in real-time. For example, the current state of the local and world economy, even down to the geographical region may be updated in real-time, the unemployment rate based on various geographic locations (world, local, state, etc.), mortgage or loan rates generally, etc. In addition, federal, state, and local taxes may be updated in real-time as well, including social security and other deductions that are required to be withdrawn from the individual, the individual's spouse, or the individual's parents.

Another advantage of the present disclosure is that the control server takes into consideration not only the individual's current life situation (e.g., married, children, monthly vehicle payments, vacation expenses, etc.) as described above, but the control server also takes into consideration future projections and predictions about the individual's life in order to adequately advise the individual in the future and so the individual can prepare for the future. For instance, to understand that the individual may purchase a home while still attending post-secondary education affects the overall need (i.e., EFC subtracted from ECOA) of the individual, and as a result it is beneficial to adequately advise the individual based on that new purchase.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
displaying, using one or more processors, a series of questions relating to a current status of a user;
receiving, using the one or more processors, answers from the user to the series of questions;
determining, using the one or more processors, one or more primary recommendations based on the received answers, wherein the one or more primary recommendations advise the user how to increase the amount of financial assistance the user receives from a financial institution; and
providing, using the one or more processors, the one or more primary recommendations to the user.

2. The method of claim 1, further comprising determining, using the one or more processors, secondary projections based on the received answers from the user, wherein the secondary projections are based on either personal developments of the user, external factors unrelated to the user, or both.

3. The method of claim 2, further comprising:
generating, using the one or more processors, future primary recommendations based on the secondary projections.

4. The method of claim 2, wherein personal developments of the user include future events affecting a career or salary of the user, the effect of marriage on the user, the effect of re-location on the user, or the user having children.

5. The method of claim 2, wherein the external factors include unemployment rate of a geographical region, lending rates, actuary data unique to the user, actuary data related to offspring of the user, or actuary data related to a spouse of the user.

6. The method of claim 5, wherein the external factors are updated in real-time, such that when the user inputs answers to the series of questions, the future primary recommendations are based on up-to-date information.

7. The method of claim 1, wherein the primary recommendations is based on whether or not one or more of the user, a spouse of the user, or a parent of the user is self-employed.

8. A system, comprising:
memory; and
one or more processors operatively coupled to the memory, wherein the one or more processors are configured to:
display a series of questions relating to a current status of a user;
receive answers from the user to the series of questions;
determine one or more primary recommendations based on the received answers, wherein the one or more primary recommendations advise the user how to increase the amount of financial assistance the user receives from a financial institution; and
provide the one or more primary recommendations to the user.

9. The system of claim 8, wherein the one or more processors are further configured to determine secondary projections based on the received answers from the user, wherein the secondary projections are based on either personal developments of the user, external factors unrelated to the user, or both.

10. The system of claim 9, wherein the one or more processors are further configured to generate future primary recommendations based on the secondary projections.

11. The system of claim 9, wherein personal developments of the user include future events affecting a career or salary of the user, the effect of marriage on the user, the effect of re-location on the user, or the user having children.

12. The system of claim 9, wherein the external factors include unemployment rate of a geographical region, lending rates, actuary data unique to the user, actuary data related to offspring of the user, or actuary data related to a spouse of the user.

13. The system of claim 12, wherein the external factors are updated in real-time, such that when the user inputs answers to the series of questions, the future primary recommendations are based on up-to-date information.

14. The system of claim 8, wherein the primary recommendations is based on whether or not one or more of the user, a spouse of the user, or a parent of the user is self-employed.

15. A non-transitory, tangible machine readable medium on which instructions are stored, the instructions, when executed by a processor cause the processor to perform a method:
displaying a series of questions relating to a current status of a user;
receiving answers from the user to the series of questions;
determining one or more primary recommendations based on the received answers, wherein the one or more primary recommendations advise the user how to increase the amount of financial assistance the user receives from a financial institution; and
providing the one or more primary recommendations to the user.

16. The non-transitory computer readable medium of claim 15, further comprising determining secondary projections based on the received answers from the user, wherein the secondary projections are based on either personal developments of the user, external factors unrelated to the user, or both.

17. The non-transitory computer readable medium of claim 16, further comprising:
generating future primary recommendations based on the secondary projections.

18. The non-transitory computer readable medium of claim 16, wherein personal developments of the user include future events affecting a career or salary of the user, the effect of marriage on the user, the effect of re-location on the user, or the user having children.

19. The non-transitory computer readable medium of claim 16, wherein the external factors include unemployment rate of a geographical region, lending rates, actuary data unique to the user, actuary data related to offspring of the user, or actuary data related to a spouse of the user.

20. The non-transitory computer readable medium of claim 19, wherein the external factors are updated in real-time, such that when the user inputs answers to the series of questions, the future primary recommendations are based on up-to-date information.
